(19) United States
(12) Patent Application Publication
(10) Pub. No.: US 2020/0236740 A1
(43) Pub. Date: Jul. 23, 2020

(54) HEATER DEVICE

(71) Applicant: DENSO CORPORATION, Kariya-city (JP)

(72) Inventors: Yusuke TANAKA, Kariya-city (JP); Kimitake ISHIKAWA, Kariya-city (JP); Hideki SEKI, Kariya-city (JP); Hirokazu YAMADAKI, Kariya-city (JP); Tatsushi DOMON, Kariya-city (JP)

(21) Appl. No.: 16/842,207

(22) Filed: Apr. 7, 2020

Related U.S. Application Data
(63) Continuation of application No. PCT/JP2018/037972, filed on Oct. 11, 2018.

(30) Foreign Application Priority Data
Oct. 17, 2017 (JP) 2017-201254
Jun. 29, 2018 (JP) 2018-124916

(51) Int. Cl. H05B 1/02

(52) U.S. Cl. CPC H05B 1/0294; G06F 3/0446

(57) ABSTRACT

A heater device includes a planar heat generating portion configured to generate heat when being energized, a detection circuit having a plurality of planar electrodes disposed on one surface side of the heat generating portion, and a controller configured to control an amount of energization to the heat generating portion based on a detection result of the detection circuit. The heat generating portion and the plurality of electrodes are disposed in parallel with each other. The heater device is configured to have a heat generating region in which the heat generating portion is present and a non-heat generating region in which the heat generating portion is not present when the plurality of electrodes and the heat generating portion are projected in a direction perpendicular to the plurality of electrodes and the heat generating portion. Furthermore, the plurality of electrodes include a heat-diffusion promoting portion provided to be included at least in the non-heat generating region.

### CROSS REFERENCE TO RELATED APPLICATION

The present application is a continuation application of International Patent Application No. PCT/JP2018/037972 filed on Oct. 11, 2018, which designated the U.S. and claims the benefit of priority from Japanese Patent Applications No. 2017-201254 filed on Oct. 17, 2017 and No. 2018-124916 filed on Jun. 29, 2018. The entire disclosures of all of the above applications are incorporated herein by reference.

### TECHNICAL FIELD

The present invention relates to a heater device.

### BACKGROUND

A heater device may include a main body having a heat generating portion that generates heat when being energized, and a detection portion having a plurality of conductive portions. The detection portion detects an approach or contact of an object in the surroundings of the main body based on a change in the electric field formed around the plurality of conductive portions.

### SUMMARY

The present disclosure provides a heater device that includes a plurality of electrodes having a heat-diffusion promoting portion. The heat-diffusion promoting portion is configured to be included in at least a non-heat generating region and to promote heat diffusion so that heat propagated from a heat generating portion is diffused in a planar direction of the plurality of electrodes.

### BRIEF DESCRIPTION OF DRAWINGS

FIG. 1 is a diagram showing a state in which a heater device of a first embodiment is mounted on a vehicle.

FIG. 2A is a front view of the heater device of the first embodiment.

FIG. 2B is a view of a plurality of electrodes through an insulating layer of the heater device from an occupant side.

FIG. 2C is a view of heat generating portions through the insulating layer, the plurality of electrodes, and an insulating substrate of the heater device from an occupant side.

FIG. 3 is a cross-sectional view taken along the line III-Ill in FIG. 2.

FIG. 4 is an enlarged view showing the heat generating portions and electrodes of the heater device of the first embodiment.

FIG. 5 is a cross-sectional view taken along the line V-V in FIG. 4.

FIG. 6 is a cross-sectional view taken along the line VI-VI in FIG. 4.

FIG. 7 is a diagram for explaining an electric field formed between a transmitting electrode and a receiving electrode.

FIG. 8 is a block diagram of the heater device of the first embodiment.

FIG. 9 is a flowchart of a controller in the heater device of the first embodiment.

FIG. 10 is a front view of a heater device of a second embodiment, showing heat generating portions and electrodes by hatching.

FIG. 11 is a front view of a heater device of a third embodiment, showing heat generating portions and electrodes by hatching.

FIG. 12 is a front view of a heater device of a fourth embodiment, showing heat generating portions and electrodes by hatching.

FIG. 13 is a front view of a heater device of a fifth embodiment, showing heat generating portions and electrodes by hatching.

FIG. 14 is a front view of the heater device of a sixth embodiment.

FIG. 15 is a view of a plurality of electrodes through an insulating layer of the heater device from an occupant side.

FIG. 16 is a view of a heat generating portion through the insulating layer, the plurality of electrodes, and an insulating substrate of the heater device from an occupant side.

### DESCRIPTION OF EMBODIMENTS

A heater device of an example includes a heat generating portion that generates heat when being energized, and a detection portion having a plurality of conductive portions. The detection portion detects an approach or contact of an object in the surroundings of the main body based on a change in the electric field formed around the plurality of conductive portions. The heater device further includes a controller that suppresses the energization of the heat generating portion when the object in the surroundings of the main portion is detected by the detection portion. In this case, when an approach or contact of the object continues, the user can be prevented from feeling uncomfortable in terms of heat.

The heater device may be configured such that the heat generating portions are distributed and arranged in a plurality of portions of the heater device and a member having a thermal conductivity lower than that of the heat generating portion is disposed to surround each of the heat generating portions in order to suppress the transfer of heat in the planar direction of the heat generating portions. With this configuration, when the object comes into contact with the main body, the temperature of a contact part of the main body is quickly decreased.

According to the studies conducted by the inventors of the present applicant, the heater device of the above example does not sufficiently diffuse and dissipate heat generated by the heat generating portions in the planar direction. Consequently, the temperature distribution on a heat generating surface becomes uneven, failing to stably provide warm feeling to the user.

The present disclosure is to provide warm feeling to a user more stably and to prevent the user from feeling uncomfortable in terms of heat when an approach or contact of an object continues.

According to an exemplar embodiment of the present disclosure, a heater device includes: a planar heat generating portion configured to generate heat when being energized; a detection circuit having a plurality of planar electrodes disposed on one surface side of the heat generating portion and configured to detect an approach or a contact of an object to the plurality of electrodes based on a change in a capacitance between the plurality of electrodes; and a controller configured to control an amount of energization to the heat generating portion based on a detection result of the detection circuit. The heat generating portion and the plurality of electrodes are disposed in parallel with each other. The heater device is configured to have a heat generating region in which the heat generating portion is present and a non-heat generating region in which the heat generating portion is not present when the plurality of electrodes and the heat generating portion are projected in a direction perpendicular to the plurality of electrodes and the heat generating portion. Furthermore, the plurality of electrodes include a heat-diffusion promoting portion provided to be included at least in the non-heat generating region, and the heat-diffusion promoting portion is configured to promote heat diffusion in which heat propagated from the heat generating portion is diffused in a planar direction of the plurality of electrodes.

With this configuration, the plurality of electrodes include the heat-diffusion promoting portion configured to be included in at least the non-heat generating region and which promotes heat diffusion in which heat propagated from the heat generating portion is diffused in the planar direction of the plurality of electrodes. Therefore, the heater device provides warm feeling to the user more stably and can prevent the user from feeling uncomfortable in terms of heat when the approach or contact of the object continues.

It is noted that a reference character with a parenthesis attached to each constituent element and the like indicates an example of the correspondence relationship between the constituent element and a specific constituent element and the like described in the embodiment described later.

Hereinafter, embodiments of the present disclosure will be described with reference to the drawings. In the following respective embodiments, the same or equivalent parts are denoted by the same reference characters throughout the drawings.

### First Embodiment

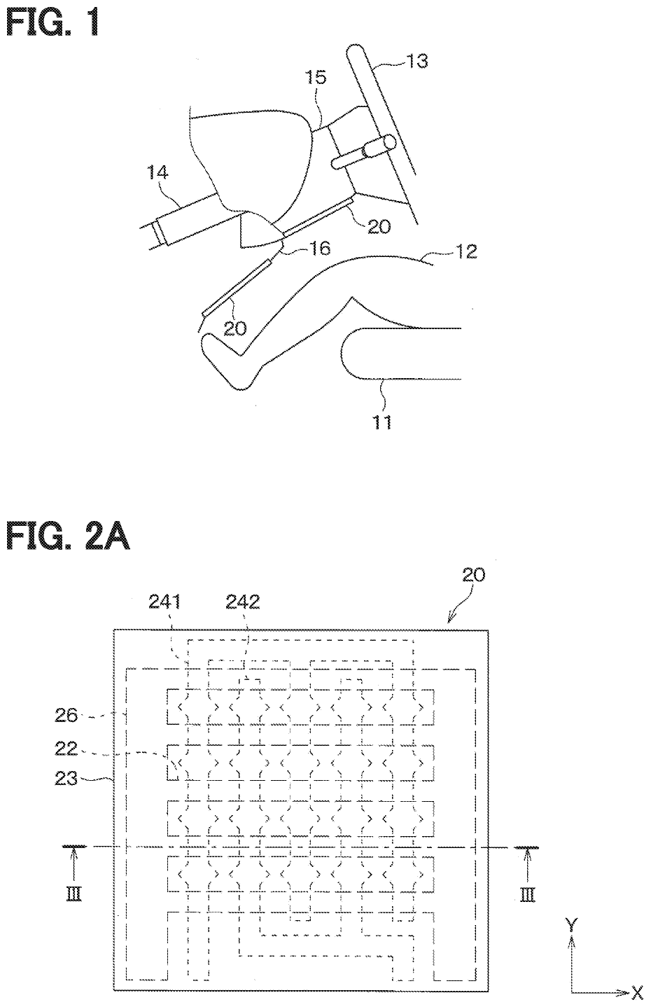

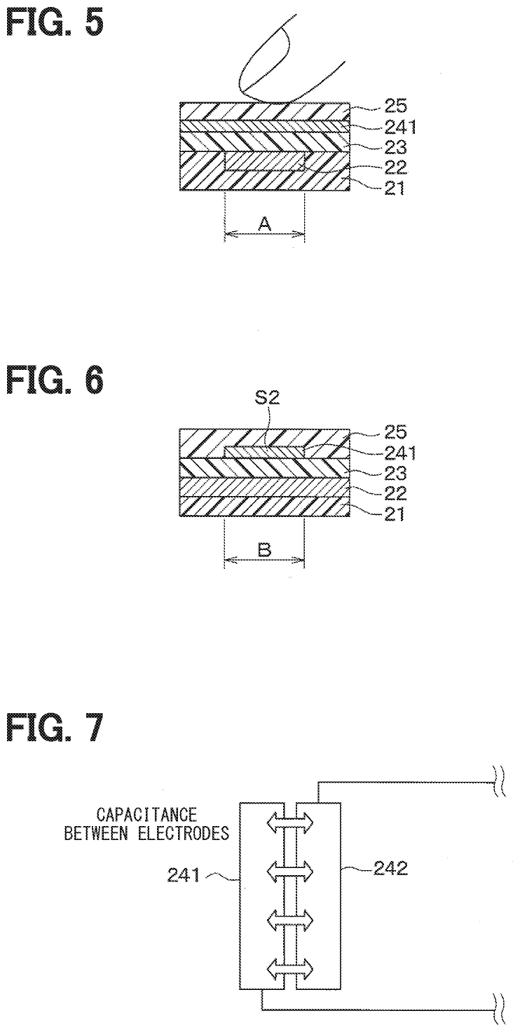

A heater device of a first embodiment will be described with reference to FIGS. 1 to 9. In FIG. 1, a heater device 20 according to the first embodiment is installed in a cabin of a moving body, such as a road traveling vehicle. The heater device 20 constitutes a part of an air-heating device for the cabin. The heater device 20 is an electric heater that generates heat by being supplied with electric power from a power source, such as a battery or a generator mounted on the moving body. The heater device 20 is formed in a thin plate shape. The heater device 20 generates heat when supplied with the electric power. The heater device 20 radiates radiant heat mainly in a direction perpendicular to its surface in order to warm an object positioned in the direction perpendicular to its surface.

A seat 11 on which an occupant 12 sits is installed in the cabin. The heater device 20 is installed in the cabin so as to radiate radiant heat to the feet of the occupant 12. The heater device 20 can be used as a device that makes the occupant 12 feel warm quickly, for example, immediately after the start-up of another air-heating device. The heater device 20 is installed on a wall surface of the interior in the cabin. The heater device 20 is installed so as to face the occupant 12 in an assumed normal posture. For example, the heater device 20 can be installed on a lower surface of a steering column cover 15 which is provided to cover a steering column 14 for supporting a steering 13 so as to face the occupant 12. Further, the heater device 20 can be installed on a dashboard 16 located under the steering column cover 15 so as to face the occupant 12.

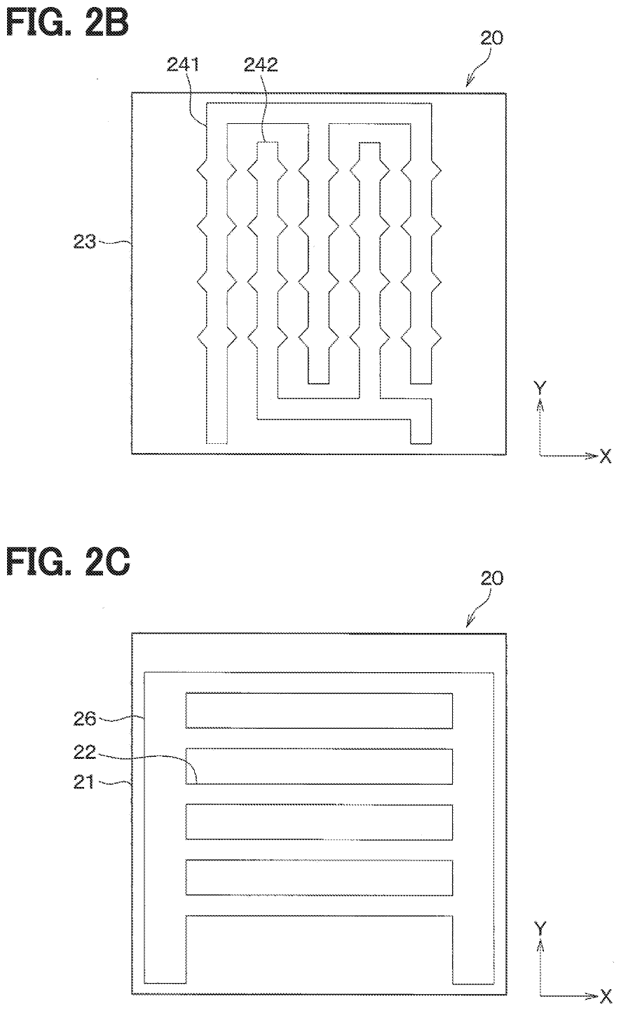

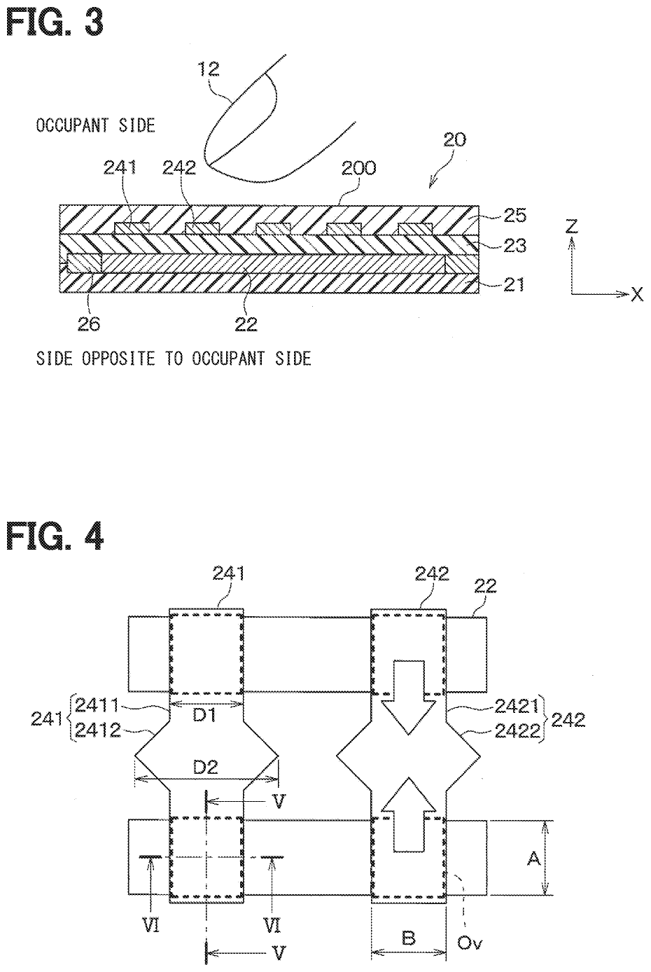

Next, the heater device 20 of the first embodiment will be described with reference to FIGS. 2 to 8. In FIGS. 2 and 3, the heater device 20 expands along the X-Y plane defined by the X axis and Y axis. The heater device 20 has a thickness in the direction of the Z axis. The heater device 20 is formed in a substantially rectangular thin plate shape.

The heater device 20 includes an insulating layer 21, a plurality of heat generating portions 22, an insulating substrate 23, electrodes 241 and 242, and an insulating layer 25. The heat generating portions 22, the insulating substrate 23, the electrodes 241 and 242, and the insulating layer 25 constitute a heater main body 200. The heater device 20 is also called as a planar heater that mainly radiates radiant heat toward the direction perpendicular to its surface.

The heat generating portions 22 each form a rectangle extending in the direction of the X axis and are arranged side by side in the direction of the Y axis. The respective heat generating portions 22 are connected to each other via a heat-generating-portion electrode 26. The plurality of heat generating portions 22 are arranged regularly so as to occupy a predetermined area on the X-Y plane in the drawing.

Each of the heat generating portions 22 is connected to the heat-generating-portion electrode 26. Each heat generating portion 22 generates heat when supplied with electric power via the heat-generating-portion electrode 26. The respective heat generating portions 22 are disposed on one surface side of the insulating substrate 23, i.e., on the side opposite to the occupant side.

Each heat generating portion 22 is made of material that has a low electrical resistance. Each heat generating portion 22 can be made of metal material. The material of each heat generating portion 22 is selected from material having a thermal conductivity lower than that of copper. For example, each heat generating portion 22 can be formed using metal, such as copper, an alloy of copper and tin, silver, tin, stainless steel, nickel, or nichrome, or an alloy containing any one or more of these metals.

The heat generating portion 22 is heated to a predetermined radiation temperature and thereby can radiate the radiant heat to make the occupant 12, i.e., a person feels warm. Each heat generating portion 22 is made of material that has a high thermal conductivity.

Each heat-generating-portion electrode 26 forms a rectangular shape that extends in the direction of the X axis. The heat-generating-portion electrodes 26 are arranged on both ends of the plurality of heat generating portions 22 in the direction of the Y axis. Each heat-generating-portion electrode 26 is made of material that has a low electrical resistance.

The insulating layer 21 that has a thermal conductivity lower than that of the heat generating portion 22 is disposed on one surface side of the insulating substrate 23, i.e., on the side opposite to the occupant side. The insulating layer 21 is disposed to cover the heat generating portions 22 from one surface side of the insulating substrate 23. The insulating layer 21 has high insulating properties, and is made of, for example, a polyimide film, insulating resin, or the like.

The heat generating portions 22 each have a thin film shape and are distributed and arranged on one surface side of the insulating substrate 23. Therefore, the heat generating portion 22 of the present embodiment has a lower heat capacity, compared to a heat generating layer formed in a thick plate shape.

In this way, a heat generating layer of the present embodiment has a low heat capacity and a high thermal resistance, and has a feature that when coming into contact with an object, the transfer of heat in the planar direction of the heat generating portion 22 is suppressed, thus quickly decreasing the temperature of a contact part of the heat generating layer. The thickness of each of the plurality of heat generating portions 22 is preferably 50 microns or less, and more preferably 20 microns or less in order to sufficiently reduce the transfer of heat in the planar direction of the heat generating layer.

The insulating substrate 23 is made of a resin material that provides excellent electrical insulating properties and resists high temperatures. Specifically, the insulating substrate 23 is made of a resin film. A plurality of pairs of electrodes 24 are arranged on one surface side of the insulating substrate 23. The insulating substrate 23 has a thermal conductivity lower than that of the heat generating portion 22.

Each of the electrodes 241 and 242 forms a comb shape. The electrode 241 is a transmitting electrode, while the electrode 242 is a receiving electrode. The electrodes 241 and 242 are formed on the other surface of the insulating substrate 23. That is, the electrodes 241 and 242 are formed on the occupant side surface.

The heater device 20 of the present embodiment has a heat generating region in which the heat generating portion 22 is present and a non-heat generating region in which the heat generating portion 22 is not present when a plurality of electrodes 241 and 242 and the heat generating portion 22 are projected in the direction perpendicular to the plurality of electrodes 241 and 242 and the heat generating portion 22.

Further, when a plurality of electrodes 241 and 242 and the heat generating portion 22 are projected in the direction perpendicular to the plurality of electrodes 241 and 242 and the heat generating portion 22, the heater device 20 of the present embodiment has overlapping regions Ov where the heat generating portion 22 and the electrode 241 or 242 overlap and non-overlapping regions where the heat generating portion 22 and the electrodes 241 and 242 do not overlap.

As shown in FIG. 4, the electrode 241 includes a linear portion 2411 that has a predetermined line width D1 and a wide portion 2412 that has a line width D2 wider than the predetermined line width D1. The electrode 242 includes a linear portion 2421 that has the predetermined line width D1 and a wide portion 2422 that has a line width D2 wider than the predetermined line width D1.

The wide portions 2412 and 2422 are formed to be included in the non-heat generating region. The wide portions 2412 and 2422 promote heat diffusion in which heat propagated from the heat generating portion 22 to the electrodes 241 and 242 is diffused in the planar direction of the electrodes 241 and 242.

As shown in FIGS. 4 to 6, in each of the overlapping regions Ov, a volume V2 of the electrode 241 or 242 included in the overlapping region Ov is equal to or less than a volume V1 of the heat generating portion 22 included in the overlapping region Ov. Specifically, in each of the overlapping regions Ov, the thickness of the electrode 241 or 242 included in the overlapping region Ov is equal to or less than the thickness of the heat generating portion 22 included in the overlapping region Ov. That is, in each of the overlapping regions Ov, the heat capacity of the electrode 241 or 242 included in the overlapping region Ov is equal to or less than the heat capacity of the heat generating portion 22 included in the overlapping region Ov.

Each of the electrode 241 and the electrode 242 is made of material that has a high thermal conductivity. Specifically, each of the electrode 241 and the electrode 242 is formed of a conductive metal, such as copper. It is noted that the electrodes 241 and 242 are formed of the same material. Each of the electrodes 241 and 242 has a thermal conductivity higher than that of the insulating substrate 23.

The electrode 241 and the electrode 242 each are arranged regularly so as to occupy a predetermined area on the X-Y plane in the drawing. Each of the electrodes 241 and 242 has the predetermined area for generating a capacitance required for detection of the capacity, on the X-Y plane in the drawing.

When a predetermined voltage is applied between the electrodes 241 and 242, an electric field is formed between the electrodes 241 and 242 as shown in FIG. 4. When an object such as a finger approaches the heater device in this electric field, the capacitance between the electrodes 241 and 242 changes due to the electric field formed between the electrodes 241 and 242. By detecting or sensing changes in the capacitance, the approach or contact of the object, such as a finger, to each electrode 24 is detected. The heater device 20 of the present embodiment detects the approach or contact of the object by a mutual-capacitance system.

The insulating layer 25 that has a thermal conductivity lower than the electrodes 241 and 242 is disposed on the other surface side of the insulating substrate 23 with the electrodes 241 and 242. The insulating layer 25 is disposed to cover the electrodes 241 and 242 from the other surface side of the insulating substrate 23. The insulating layer 25 has high insulating properties, and is formed of, for example, a polyimide film, insulating resin, or the like.

In the present heater device 20, the insulating layer 25 having a thermal conductivity lower than that of each of the transmitting electrodes 241 and the receiving electrodes 242 is disposed between each transmitting electrode 241 and each receiving electrode 242, thereby increasing the thermal resistance in the planar direction of the heat generating layer 220. The transmitting electrodes 241 and the receiving electrodes 242 each form a thin film shape and are distributed and arranged on the other surface side of the insulating substrate 23. Therefore, each of the transmitting electrode 241 and the receiving electrode 242 of the present embodiment has a low heat capacity.

In this way, each transmitting electrode 241 and each receiving electrode 242 of the present embodiment have a low heat capacity and a high thermal resistance and have a feature that when coming into contact with an object, the transfer of heat in the planar direction of the heat generating layer is suppressed, thus quickly decreasing the temperature of the contact part of the heat generating layer.

The thickness of each of the plurality of transmitting electrodes 241 and the plurality of receiving electrodes 242 is preferably 50 microns or less. To sufficiently reduce the transfer of heat in the planar direction of the plurality of transmitting electrodes 241 and the plurality of receiving electrodes 242, the thickness of each of the transmitting electrode 241 and the receiving electrode 242 is preferably 20 microns or less.

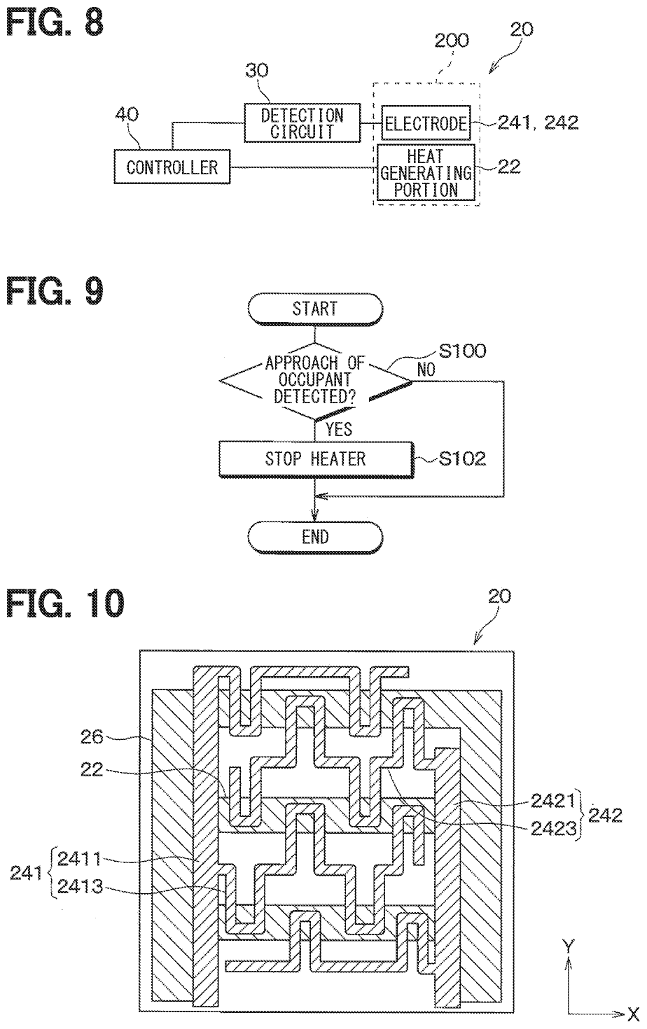

Next, a block configuration of the heater device 20 of the present embodiment will be described with reference to FIG. 8. The heater device 20 includes the heater main body 200, a detection circuit 30, and a controller 40.

The heater main body 200 includes the electrodes 241 and 242 and the heat generating portions 22.

The detection circuit 30 detects an object in the surroundings of the electrodes 241 or 242 by forming an electric field between the electrodes 241 and 242. Specifically, the detection circuit 30 forms the electric field between the electrodes 241 and 242 by applying a predetermined voltage between the electrodes 241 and 242 and thereby detects a change in the electric field between the electrodes 241 and 242. In this way, the detection circuit 30 detects the approach of an object present in the surroundings of the electrodes 241 or 242, or the contact of an object with the electrode 241 or 242 via the insulating layer 25. When detecting the approach or contact of the object to the electrode 241 or 242, the detection circuit 30 sends a signal indicative of the approach or contact of the object, to the controller 40.

The controller 40 is configured as a computer including a CPU, a memory, and the like, and the CPU performs various types of processing in accordance with a program stored in the memory. The controller 40 performs processing for controlling the amount of electricity supplied to the heat generating portion 22 based on the signal from the detection circuit 30. The memory is a non-transitional substantive storage medium.

Next, the processing performed by the controller 40 will be described with reference to FIG. 9. When the heater device 20 is powered on, the controller 40 starts energization of the heat generating portion 22 and concurrently repeats the processing shown in FIG. 9. Each control step in the flowchart configures each of various types of function implementation means included in the controller 40.

In step S100, the controller 40 determines whether the approach or contact of an occupant is detected. Specifically, a pulsed voltage is applied to the transmitting electrode 241 to form an electric field between the transmitting electrode 241 and the receiving electrode 242. Consequently, as shown in FIG. 7, the electric field is formed between the transmitting electrode 241 and the receiving electrode 242.

The detection circuit 30 determines whether an object approaches or comes into contact with the plurality of electrodes 241 and 242 based on whether a voltage between the transmitting electrode 241 and the receiving electrode 242 is equal to or higher than a prescribed threshold value when a predetermined time period has elapsed from the falling of the pulsed voltage in step S100. When the object is determined to approach or come into contact with the electrodes, the detection circuit 30 outputs a signal indicative of the approach or contact of the object, to the controller 40. The controller 40 determines whether the object is detected, based on the signal output from the detection circuit 30.

Here, when the object approaches or comes into contact with at least one of the transmitting electrode 241 or the receiving electrode 242, part of the electric field formed between the transmitting electrode 241 and the receiving electrode 242 moves to a fingertip side, resulting in a reduced electric field detected by the receiving electrode 242. Thus, the detection circuit 30 sends the signal indicative of the approach or contact of the object, to the controller 40.

In this case, in the next step S102, the controller 40 stops the heater. Specifically, the controller 40 stops the energization of the heat generating portion 22.

When a signal indicative of the approach or contact of the object is not output from the detection circuit 30 to the controller 40, the controller 40 finishes the present processing without executing the process of step S102.

In the heater device of the present embodiment, once the occupant comes into contact with the heater surface, the temperature of a contact part on the heater surface quickly decreases even when the heater temperature is increased up to a temperature (for example, about 100° C.) that can provides warm feeling to the occupant. Specifically, the temperature of the contact part decreases down to 52° C. or lower at which a reflex reaction of the occupant due to heat does not occur. Consequently, the safe heater device can be provided.

Further, the heater device of the present embodiment stops the energization of the heat generating portion 22 when detecting the approach or contact of the object in the surroundings. Therefore, the heater device can prevent the occupant from feeling uncomfortable in terms of heat, for example, even when the contact of the occupant with the heater surface continues for a relatively long time period without making the user aware of the contact with the surface of the heater device.

As described above, the present heater device includes the planar heat generating portion 22 that generates heat by being energized. The heater device includes a plurality of planar electrodes 241 and 242 arranged on one surface side of the heat generating portion, and the detection circuit 30 that detects the approach or contact of the object to the plurality of electrodes based on a change in the capacitance between the plurality of electrodes. The heater device further includes the controller 40 that controls the amount of electricity supplied to the heat generating portion based on the detection result provided by the detection circuit 30. The heat generating portion 22 and the plurality of electrodes 241 and 242 are arranged in parallel with each other. When a plurality of electrodes 241 and 242 and the heat generating portion 22 are projected in the direction perpendicular to the plurality of electrodes 241 and 242 and the heat generating portion 22, the heater device has a heat generating region in which the heat generating portion 22 is present and a non-heat generating region in which the heat generating portion 22 is not present. The plurality of electrodes include a heat-diffusion promoting portion formed to be included in at least the non-heat generating region. The heat-diffusion promoting portion promotes heat diffusion in which heat propagated from the heat generating portion is diffused in the planar direction of the plurality of electrodes. The heat-diffusion promoting portions are wide portions 2412 and 2422.

With this configuration, the plurality of electrodes 241 and 242 include the heat-diffusion promoting portion formed to be included in at least the non-heat generating region and that promotes heat diffusion in which heat propagated from the heat generating portion 22 is diffused in the planar direction of the plurality of electrodes 241 and 242. The heat-diffusion promoting portions are the wide portions 2412 and 2422. Therefore, the heater device provides warm feeling to the user more stably and can prevent the user from feeling uncomfortable in terms of heat when the approach or contact of the object continues.

In each of overlapping regions where the heat generating portion 22 and the plurality of electrodes 241 and 242 overlap each other, the volume of the electrode 241 or 242 included in the overlapping region is equal to or less than the volume of the heat generating portion 22 included in the overlapping region when the plurality of electrodes 241 and 242 and the heat generating portion 22 are projected in the direction perpendicular to the plurality of electrodes 241 and 242 and the heat generating portion 22. That is, in each of the overlapping regions, the heat capacity of the electrode 241 or 242 included in the overlapping region is equal to or less than the heat capacity of the heat generating portion 22 included in the overlapping region. Therefore, when the object comes into contact with the electrode 241 or 242, the temperature of the contact part can be quickly decreased because the heat capacity of each of the electrodes 241 and 242 is equal to or less than the heat capacity of the heat generating portion 22, making it possible to reduce the uncomfortable feeling of the user in terms of heat.

The plurality of electrodes 241 and 242 include linear portions 2411 and 2421 and wide portions 2412 and 2422. Each of the linear portions 2411 and 2421 has a predetermined line width. Each of the wide portions 2412 and 2422 is formed to be included in at least the non-heat generating region and has a line width wider than the predetermined line width. The heat-diffusion promoting portion is the wide portion.

Thus, the heat-diffusion promoting portion can be configured by the wide portion 2412 or 2422 that is formed to be included in at least the non-heat generating region and has a line width wider than the predetermined line width. The temperature distribution in the planar direction of the plurality of electrodes 241 and 242 can be equalized by the wide portions 2412 and 2422.

### Second Embodiment

A heater device of a second embodiment will be described with reference to FIG. 10. In the present embodiment, the plurality of electrodes 241 and 242 include linear portions 2411 and 2421 and meandering portions 2413 and 2423. Each of the linear portions 2411 and 2421 has a predetermined line width. Each of the meandering portions 2413 and 2423 extends from at least the non-heat generating region while meandering the non-heat generating region through the heat generating region. The heat-diffusion promoting portions are the meandering portions 2413 and 2423.

The meandering portion 2413 is formed to branch from the electrode 241 and to extend while meandering between the non-heat generating region and the heat generating region. The meandering portion 2423 is formed to branch from the electrode 242 and to extend while meandering between the non-heat generating region and the heat generating region.

Heat transferred from the heat generating portion 22 to the meandering portions 2413 and 2423 in the heat generating region is diffused in the meandering portions 2413 and 2423 in the non-heat generating region in the planar direction of the plurality of electrodes 241 and 242. In this way, the meandering portions 2413 and 2423 promote the heat diffusion in which heat propagated from the heat generating portion 22 is diffused in the planar direction of the electrodes 241 and 242.

In the present embodiment, the same effects as those exhibited by the configuration common to the first embodiment can be obtained in the same manner as in the first embodiment.

The heat-diffusion promoting portion can be configured by the meandering portions 2413 and 2423 that extend from at least the non-heat generating region while meandering the non-heat generating region through the heat generating region.

### Third Embodiment

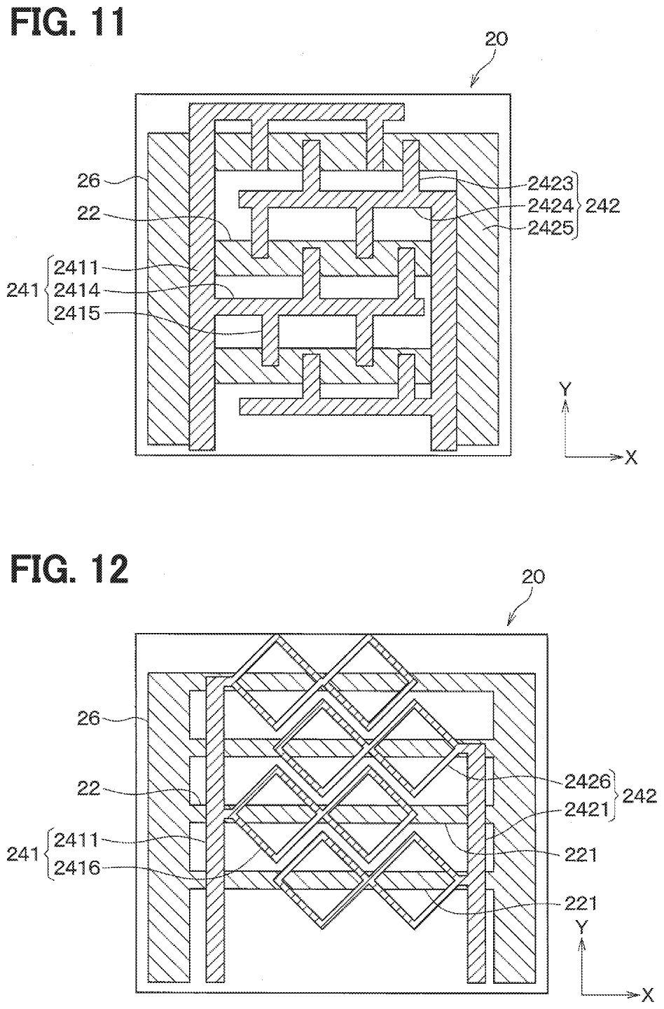

A heater device of a third embodiment will be described with reference to FIG. 11. In the present embodiment, the plurality of electrodes 241 and 242 include linear portions 2411 and 2421 and first branch portions 2414 and 2424. Each of the linear portions 2411 and 2421 has a predetermined line width. Each of the first branch portions 2414 and 2424 is formed to be included in at least the non-heat generating region and branch from the linear portion. The heat-diffusion promoting portions are the first branch portions 2414 and 2424. The plurality of electrodes 241 and 242 further include second branch portions 2415 and 2425, which are formed to be included in at least the heat generating region and branch from the first branch portions 2414 and 2424, respectively. The heat-diffusion promoting portion is configured by the first branch portion 2414 or 2424 and the second branch portion 2415 or 2425.

Therefore, the heat propagated from the heat generating portion 22 to the linear portions 2411 and 2421 can be diffused by the first branch portions 2414 and 2424 formed to be included in at least the non-heat generating region, in the planar direction of the plurality of electrodes 241 and 242.

The heater device of the present embodiment includes the second branch portions 2415 and 2425 formed to be included in at least the heat generating region and branch from the first branch portions 2414 and 2424, respectively. Therefore, the heat propagated from the heat generating portion 22 to the second branch portions 2415 and 2425 can be propagated to the first branch portions 2414 and 2424 and diffused in the planar direction of the electrodes 241 and 242 by the second branch portions 2415 and 2425, respectively.

In the present embodiment, the same effects as those exhibited by the configuration common to the first embodiment can be obtained in the same manner as in the first embodiment.

The heat-diffusion promoting portion can be configured by the first branch portions 2414 and 2424 formed to be included in at least the non-heat generating region and branch from the linear portions.

### Fourth Embodiment

A heater device of a fourth embodiment will be described with reference to FIG. 12. The heat generating portion 22 of the heater device of the present embodiment includes a plurality of straight portions 221 that are arranged at certain intervals. The plurality of electrodes 241 and 242 include rectangular heat dissipation portions 2416 and 2426, respectively, that are formed to be included in at least the non-heat generating region. Each of the rectangular heat dissipation portions 2416 and 2426 forms a rectangular shape having one side longer than the width of the straight portion. The minimum length of a gap between the plurality of rectangular heat dissipation portions 2416 and 2426 is shorter than an interval between the plurality of straight portions 221. The heat-diffusion promoting portions are the rectangular heat dissipation portions 2416 and 2426.

Each of the rectangular heat dissipation portions 2416 and 2426 has a rectangular space formed therein, thereby reducing the amount of use of conductive metal to form the rectangular heat dissipation portions 2416 and 2426.

Each side of the rectangular heat dissipation portions 2416 and 2426 is formed to extend in a direction that intersects a direction orthogonal to the longitudinal direction of the straight portion 221.

In the present embodiment, the same effects as those exhibited by the configuration common to the first embodiment can be obtained in the same manner as in the first embodiment.

In the heater device of the present embodiment, the plurality of electrodes 241 and 242 include the rectangular heat dissipation portions 2416 and 2426, respectively, that are formed to be included in at least the non-heat generating region. Each of the rectangular heat dissipation portions 2416 and 2426 forms a rectangular shape that has one side longer than the width of the straight portion. The minimum length of a gap between the plurality of rectangular heat dissipation portions 2416 and 2426 is shorter than an interval between the plurality of straight portions 221.

That is, the rectangular heat dissipation portions 2416 and 2426 are formed so as to be included in at least non-heat generating region and to be laid in the planar direction of the electrodes 241 and 242. Therefore, the heat propagated from the heat generating portions 22 to the rectangular heat dissipation portions 2416 and 2426 can be diffused by the rectangular heat dissipation portions 2416 and 2426 in the planar direction of the electrodes 241 and 242.

The first side of at least one of the plurality of rectangular heat dissipation portions 2416 faces one side of one of the rectangular heat dissipation portions 2426. The second side located adjacent to the first side is disposed to face one side of an adjacent rectangular heat dissipation portion 2426 that is disposed adjacent to the rectangular heat dissipation portion 2426 disposed to face the first side of the rectangular heat dissipation portion 2416.

Therefore, as shown in FIG. 4, the approach or contact of the object can be detected with higher accuracy, compared to when combining the capacities of one wide portion 2412 and one wide portion 2422.

### Fifth Embodiment

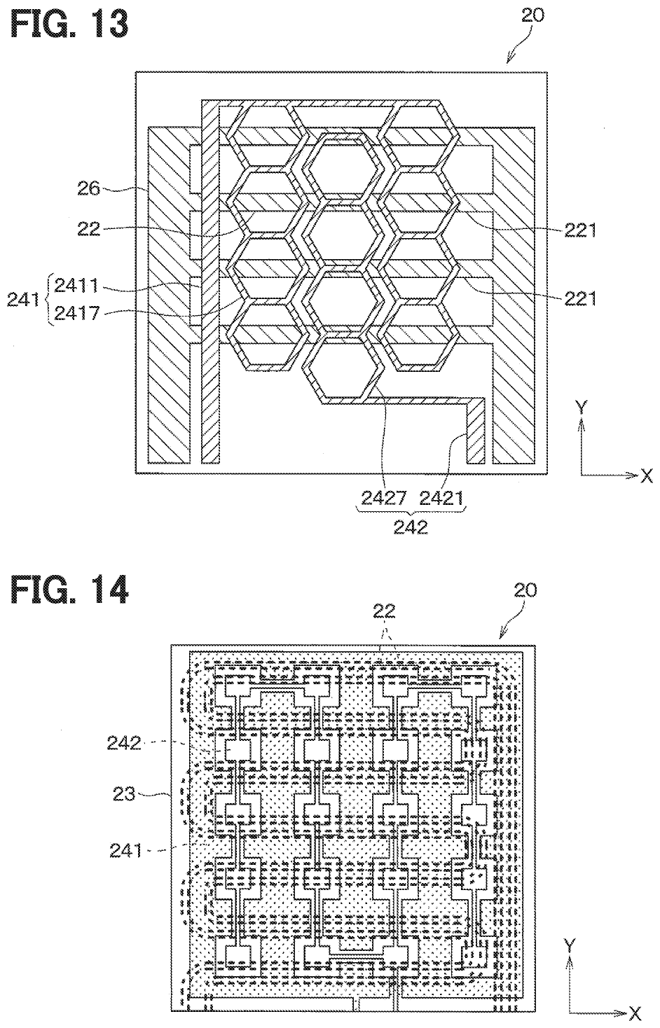

A heater device of a fifth embodiment will be described with reference to FIG. 13. The heat generating portion 22 of the heater device of the present embodiment includes the plurality of straight portions 221 that are arranged at certain intervals. The plurality of electrodes 241 and 242 have honeycomb heat dissipation portions 2417 and 2427 formed to be included in at least the non-heat generating region. Each of the honeycomb heat dissipation portions 2417 and 2427 has a hexagonal shape having one side longer than the width of the straight portion. The minimum length of a gap between the plurality of honeycomb heat dissipation portions 2417 and 2427 is shorter than the interval between the plurality of straight portions 221. The heat-diffusion promoting portions are the honeycomb heat dissipation portions 2417 and 2427.

Each side of the honeycomb heat dissipation portions 2417 and 2427 is formed to extend in a direction that intersects a direction orthogonal to the longitudinal direction of the straight portion 221.

In the present embodiment, the same effects as those exhibited by the configuration common to the first embodiment can be obtained in the same manner as in the first embodiment.

In the heater device of the present embodiment, the plurality of electrodes 241 and 242 include the honeycomb heat dissipation portions 2417 and 2427 that are formed to be included in at least the non-heat generating region. Each of the honeycomb heat dissipation portions 2417 and 2427 forms a hexagonal shape that has one side longer than the width of the straight portion. The minimum length of a gap between the plurality of honeycomb heat dissipation portions 2417 and 2427 is shorter than an interval between the plurality of straight portions 221.

That is, the honeycomb heat dissipation portions 2417 and 2427 are formed so as to be included in at least non-heat generating region and to be laid in the planar direction of the electrodes 241 and 242. Therefore, the heat propagated from the heat generating portion 22 to the rectangular heat dissipation portions 2416 and 2426 can be diffused by the honeycomb heat dissipation portions 2417 and 2427 in the planar direction of the electrodes 241 and 242.

The first side of at least one of the plurality of honeycomb heat dissipation portions 2417 faces one side of one of the plurality of honeycomb heat dissipation portions 2427. The second side located adjacent to the first side is disposed to face one side of an adjacent rectangular heat dissipation portion 2426 that is disposed adjacent to the honeycomb heat dissipation portion 2427 disposed to face the first side of the honeycomb heat dissipation portion 2417.

Therefore, as shown in FIG. 4, the approach or contact of the object can be detected with higher accuracy, compared to when combining the capacities of one wide portion 2412 and one wide portion 2422.

### Sixth Embodiment

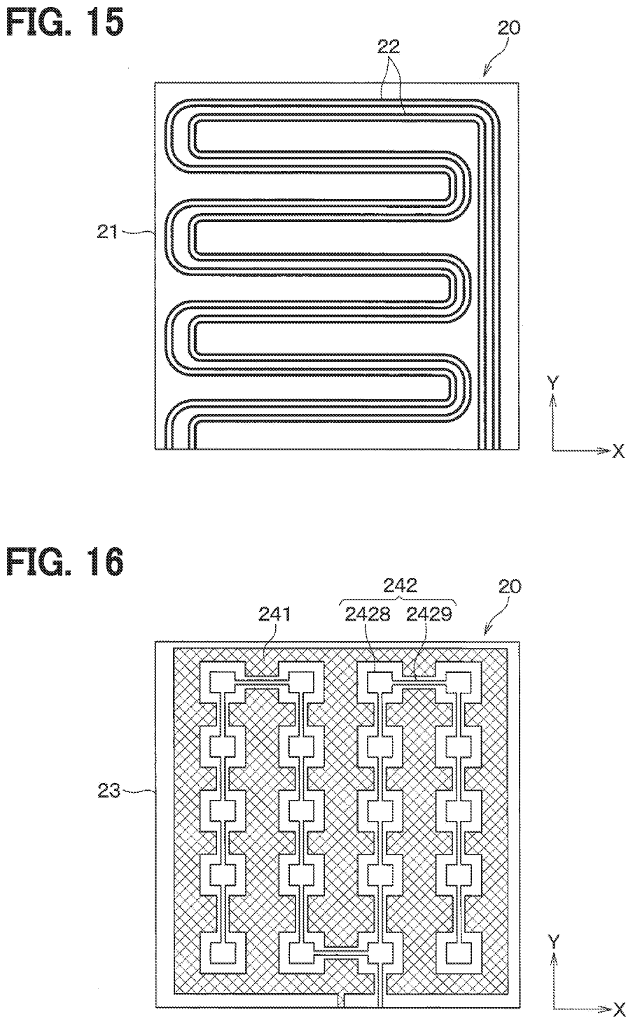

A heater device of a sixth embodiment will be described with reference to FIGS. 14 to 16. The heater device of the present embodiment includes a receiving electrode 242 and a transmitting electrode 241 disposed to surround the receiving electrode 242. The receiving electrode 242 includes a plurality of rectangular portions 2428 each having a rectangular shape and a linear portion 2429 connecting respective adjacent rectangular portions 2428. The receiving electrode 242 is formed to extend while meandering on the plane. The transmitting electrode 241 is formed to surround the peripheries of the rectangular portions 2428 and the linear portions 2429. The transmitting electrode 241 is formed in a metal mesh.

The heater device of the present embodiment includes two linear heat generating portions 22. The respective heat generating portions 22 are formed side by side to extend while meandering on the plane.

The receiving electrode 242 is formed to extend from at least the non-heat generating region while meandering the non-heat generating region through the heat generating region. Further, the transmitting electrode 241 is formed to extend from at least the non-heat generating region through the heat generating region to the non-heat generating region again.

The overlapping relationship between the heat generating portion 22 and each of the receiving electrode 242 and the transmitting electrode 241 differs depending on their locations when the plurality of electrodes 241 and 242 and the heat generating portion 22 are projected in the direction perpendicular to the plurality of electrodes 241 and 242 and the heat generating portion 22.

In the present embodiment, the same effects as those exhibited by the configuration common to the first embodiment can be obtained in the same manner as in the first embodiment.

The heater device of the present embodiment includes two linear heat generating portions 22, but may have one or three or more heat generating portions 22.

### Other Embodiments

(1) The heater device is installed on a road traveling vehicle as described by way of example in the above respective embodiments, but is not limited to the road traveling vehicle and can also be installed in a cabin of a moving body, such as a ship or an airplane.
(2) In the above fourth and fifth embodiments, a space is provided inside the rectangular heat dissipation portion 2416 or 2426 or the honeycomb heat dissipation portion 2417 or 2427, but such a space may be dispensed with.
(3) In the above fourth and fifth embodiments, the rectangular heat dissipation portion 2416 or 2426 or honeycomb heat dissipation portion 2417 or 2427 is formed as a part of the plurality of electrodes 241 and 242. In contrast, parts of the plurality of electrodes 241 and 242 may be configured in any shape other than the rectangle and the hexagon, such as a triangle, an octagon, and a circle.

It is noted that the present disclosure is not limited to the above-mentioned embodiments and various modifications can be made to these embodiments as appropriate. The above-mentioned respective embodiments are not independent of each other and can be combined as appropriate except when the combination thereof is obviously impossible. In the above-mentioned respective embodiments, it is needless to say that the elements included in the embodiments are not necessarily essential, particularly except when they are clearly indicated to be essential, unless otherwise considered to be clearly essential in principle, and the like. In the above-mentioned respective embodiments, when referring to a specific value in terms of the number, numerical value, quantity, range, and the like of a constituent element of the embodiments, the constituent element is not limited to the specific value, particularly except when it is clearly indicated to be essential, unless otherwise considered to be clearly limited to the specific value in principle, and the like. In the above-mentioned respective embodiments, when referring to the material, shape, positional relationship, and the like of the constituent element or the like, the constituent element is not limited to the specific material, shape, positional relationship, and the like particularly unless otherwise specified, except when it is limited to the specific material, shape, positional relationship in principle, or the like.

According to a first aspect described in a part or all of the above-mentioned respective embodiments, a heater device includes a planar heat generating portion that generates heat by being energized. The heater device includes: a detection circuit including a plurality of planar electrodes disposed on one surface side of the heat generating portion, the detection circuit detecting approach or contact of an object to the plurality of electrodes based on a change in a capacitance between the plurality of electrodes; and a controller that controls an amount of energization to the heat generating portion based on a detection result of the detection circuit. The heat generating portion and the plurality of electrodes are disposed in parallel with each other. The heater device has a heat generating region in which the heat generating portion is present and a non-heat generating region in which the heat generating portion is not present when the plurality of electrodes and the heat generating portion are projected in a direction perpendicular to the plurality of electrodes and the heat generating portion. The plurality of electrodes include a heat-diffusion promoting portion included in at least the non-heat generating region. The heat-diffusion promoting portion promotes heat diffusion in which heat propagated from the heat generating portion is diffused in a planar direction of the plurality of electrodes.

According to a second aspect, in each of overlapping regions where the heat generating portion and the plurality of electrodes overlap each other, a volume of the electrode included in the overlapping region is smaller than a volume of the heat generating portion included in the overlapping region when the plurality of electrodes and the heat generating portion are projected in the direction perpendicular to the plurality of electrodes and the heat generating portion. That is, in each of the overlapping regions, the heat capacity of the electrode included in the overlapping region is smaller than the heat capacity of the heat generating portion included in the overlapping region. Therefore, when the object comes into contact with the electrode, the temperature of the contact part can be quickly decreased, making it possible to reduce the uncomfortable feeling of the user in terms of heat.

According to a third aspect, the plurality of electrodes can be configured by a linear portion having a predetermined line width and a wide portion formed to be included in at least the non-heat generating region and having a line width wider than the predetermined line width. The temperature distribution in the planar direction of the plurality of electrodes can be equalized by the wide portion.

According to a fourth aspect, the plurality of electrodes include a meandering portion that extends from at least the non-heat generating region while meandering the non-heat generating region through the heat generating region, and the heat-diffusion promoting portion is the meandering portion.

Thus, the heat-diffusion promoting portion can be configured by the meandering portion that extends from at least the non-heat generating region while meandering the non-heat generating region through the heat generating region.

According to a fifth aspect, the plurality of electrodes include: a linear portion having a predetermined line width; and a first branch portion formed to be included in at least the non-heat generating region and branch from the linear portion. In this case, the heat-diffusion promoting portion is the first branch portion.

Thus, the heat-diffusion promoting portion can be configured by the first branch portion that is formed to be included in at least the non-heat generating region and branch from the linear portion.

According to a sixth aspect, the plurality of electrodes include a second branch portion formed to be included in at least the heat generating region and branch from the first branch portion.

Therefore, the heat propagated from the heat generating portion to the second branch portion can be propagated to the first branch portion and diffused in the planar direction of the electrodes by the second branch portion.

According to a seventh aspect, the heat generating portion includes a plurality of straight portions arranged at a certain interval, and the plurality of electrodes include a rectangular heat dissipation portion formed to be included in at least the non-heat generating region and forming a rectangular shape that has one side longer than a width of the straight portion. A minimum length of a gap between the plurality of rectangular heat dissipation portions is shorter than the interval between the plurality of straight portions, and the heat-diffusion promoting portion is the rectangular heat dissipation portion.

That is, the rectangular heat dissipation portion is formed to be laid in the planar direction of the electrode so as to be included in at least non-heat generating region. Therefore, the heat propagated from the heat generating portion to the rectangular heat dissipation portion can be diffused by the rectangular heat dissipation portion in the planar direction of the electrode.

According to an eighth aspect, the heat generating portion includes a plurality of straight portions arranged at a certain interval, the plurality of electrodes include a honeycomb heat dissipation portion formed to be included in at least the non-heat generating region and forming a hexagonal shape that has one side longer than a width of the straight portion. A minimum length of a gap between the plurality of honeycomb heat dissipation portions is shorter than the interval between the plurality of straight portions, and the heat-diffusion promoting portion is the honeycomb heat dissipation portion.

The honeycomb heat dissipation portion may be formed so as to be included in at least non-heat generating region and to be laid in the planar direction of the electrodes. In this case, the heat propagated from the heat generating portion to the honeycomb heat dissipation portion can be diffused in the planar direction of the electrodes.

What is claimed is:

1. A heater device comprising:
a planar heat generating portion configured to generate heat when being energized;
a detection circuit including a plurality of planar electrodes disposed on one surface side of the heat generating portion, the detection circuit being configured to detect an approach or a contact of an object to the plurality of electrodes based on a change in a capacitance between the plurality of electrodes; and
a controller configured to control an amount of energization to the heat generating portion based on a detection result of the detection circuit, wherein
the heat generating portion and the plurality of electrodes are disposed in parallel with each other,
the heater device is configured to have a heat generating region in which the heat generating portion is present and a non-heat generating region in which the heat generating portion is not present when the plurality of electrodes and the heat generating portion are projected in a direction perpendicular to the plurality of electrodes and the heat generating portion, and
the plurality of electrodes include a heat-diffusion promoting portion provided to be included at least in the non-heat generating region, the heat-diffusion promoting portion being configured to promote heat diffusion in which heat propagated from the heat generating portion is diffused in a planar direction of the plurality of electrodes.

2. The heater device according to claim 1, wherein
in each of overlapping regions where the heat generating portion and the plurality of electrodes overlap each other, a volume of the electrode included in the overlapping region is equal to or less than a volume of the heat generating portion included in the overlapping region when the plurality of electrodes and the heat generating portion are projected in the direction perpendicular to the plurality of electrodes and the heat generating portion.

3. The heater device according to claim 1, wherein
the plurality of electrodes include:
a linear portion having a predetermined line width; and
a wide portion included in at least the non-heat generating region, the wide portion having a line width wider than the predetermined line width, and
the heat-diffusion promoting portion is the wide portion.

4. The heater device according to claim 1, wherein
the plurality of electrodes include a meandering portion that extends from at least the non-heat generating region while meandering the non-heat generating region through the heat generating region, and
the heat-diffusion promoting portion is the meandering portion.

5. The heater device according to claim 1, wherein
the plurality of electrodes include: a linear portion having a predetermined line width; and a first branch portion included in at least the non-heat generating region, the first branch portion branching from the linear portion, and
the heat-diffusion promoting portion is the first branch portion.

6. The heater device according to claim 5, wherein
the plurality of electrodes include a second branch portion included in at least the heat generating region, the second branch portion branching from the first branch portion.

7. The heater device according to claim 1, wherein
the heat generating portion includes a plurality of straight portions arranged at a certain interval,
the plurality of electrodes include a plurality of rectangular heat dissipation portions configured to be included at least in the non-heat generating region, each of the rectangular heat dissipation portions having a rectangular shape that has one side longer than a width of each of the plurality of straight portions,
a minimum length of a gap between the plurality of rectangular heat dissipation portions is shorter than an interval between the plurality of straight portions, and
the heat-diffusion promoting portion includes the plurality of rectangular heat-dissipation portions.

8. The heater device according to claim 1, wherein
the heat generating portion includes a plurality of straight portions arranged at a certain interval,
the plurality of electrodes include a plurality of honeycomb heat dissipation portions formed to be included at least in the non-heat generating region, each of the honeycomb heat dissipation portions forming a hexagonal shape that has one side longer than a width of each of the plurality of straight portions,
a minimum length of a gap between the plurality of honeycomb heat dissipation portions is shorter than an interval between the plurality of straight portions, and
the heat-diffusion promoting portion includes the plurality of honeycomb heat dissipation portions.
